(19) United States
(12) Patent Application Publication
(10) Pub. No.: US 2017/0320401 A1
(43) Pub. Date: Nov. 9, 2017

(54) Magnetic Levitation Automobile Harness

(71) Applicant: Enrique Sarabia Maximiliano, San Marcos, CA (US)

(72) Inventor: Enrique Sarabia Maximiliano, San Marcos, CA (US)

(21) Appl. No.: 15/149,123

(22) Filed: May 7, 2016

(51) Int. Cl. B60L 13/04; E01B 25/30; B61B 13/00

(52) U.S. Cl. CPC B60L 13/04; B61B 13/00; E01B 25/30

(57) ABSTRACT

This invention is a harness for automobiles in order to ride a modified magnetic levitation railing system. The magnets and superconductors are used to lift and propel forward the harness. The lift points are in order to keep the automobile level and keeping the automobile from moving around. The bolt holder is to keep the automobile, wheels, suspension, and shocks in place. The Bolt Holder R4 is a specially designed part to attach to the automobiles wheels, it has a bearing and thread in order for the part to spin freely and be secured onto the automobiles wheels. The frame is designed to accommodate most automobiles. The rail drop is there to have a path for the automobile to enter/exit the harness. The bearings are there to allow the magnets, superconductors, and the automobiles wheels to spin freely as it travels to its destination and at the destination.

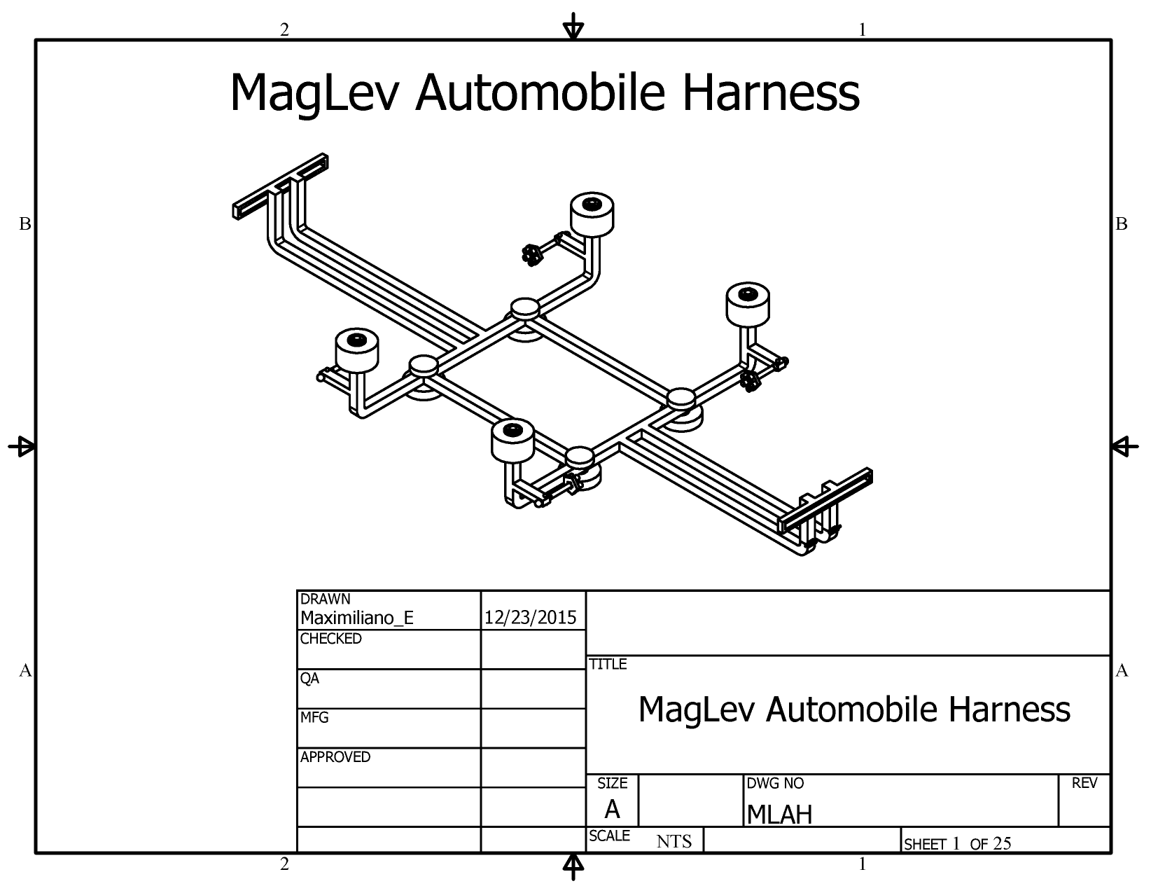

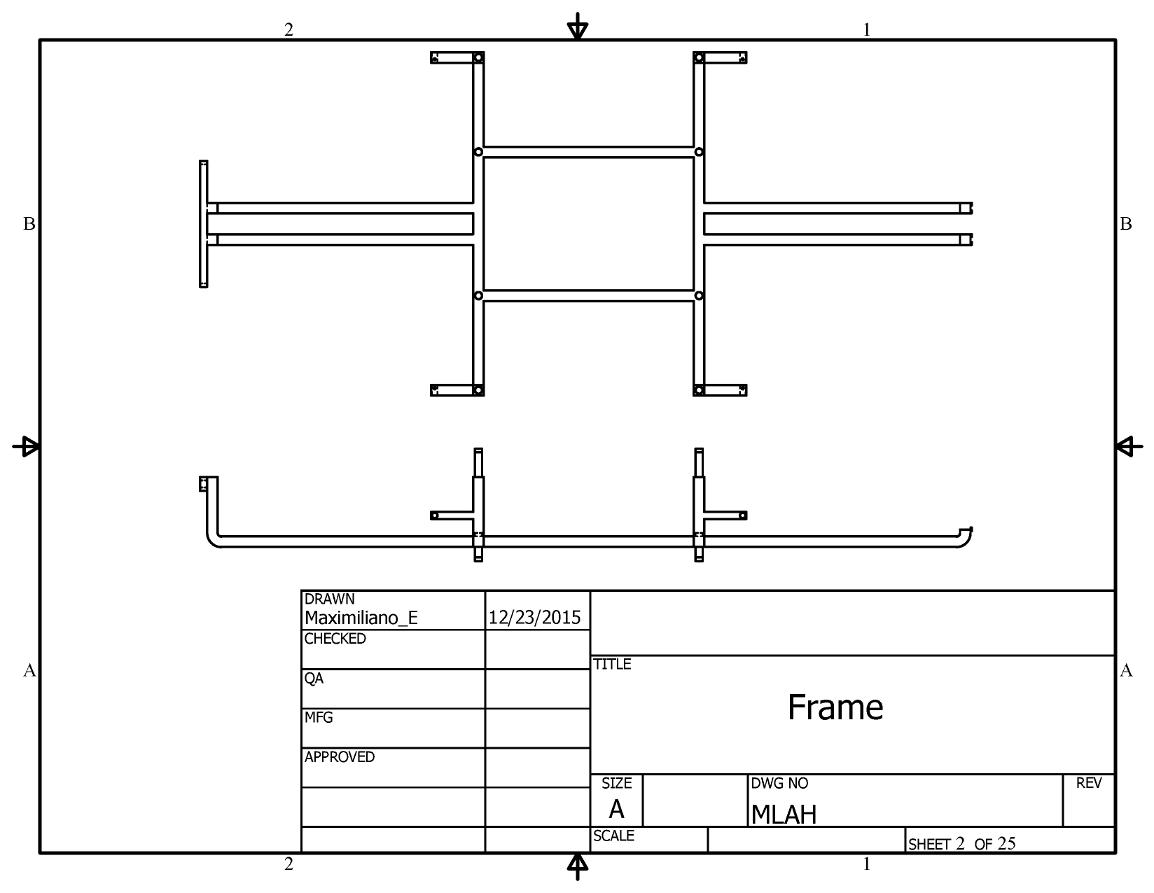

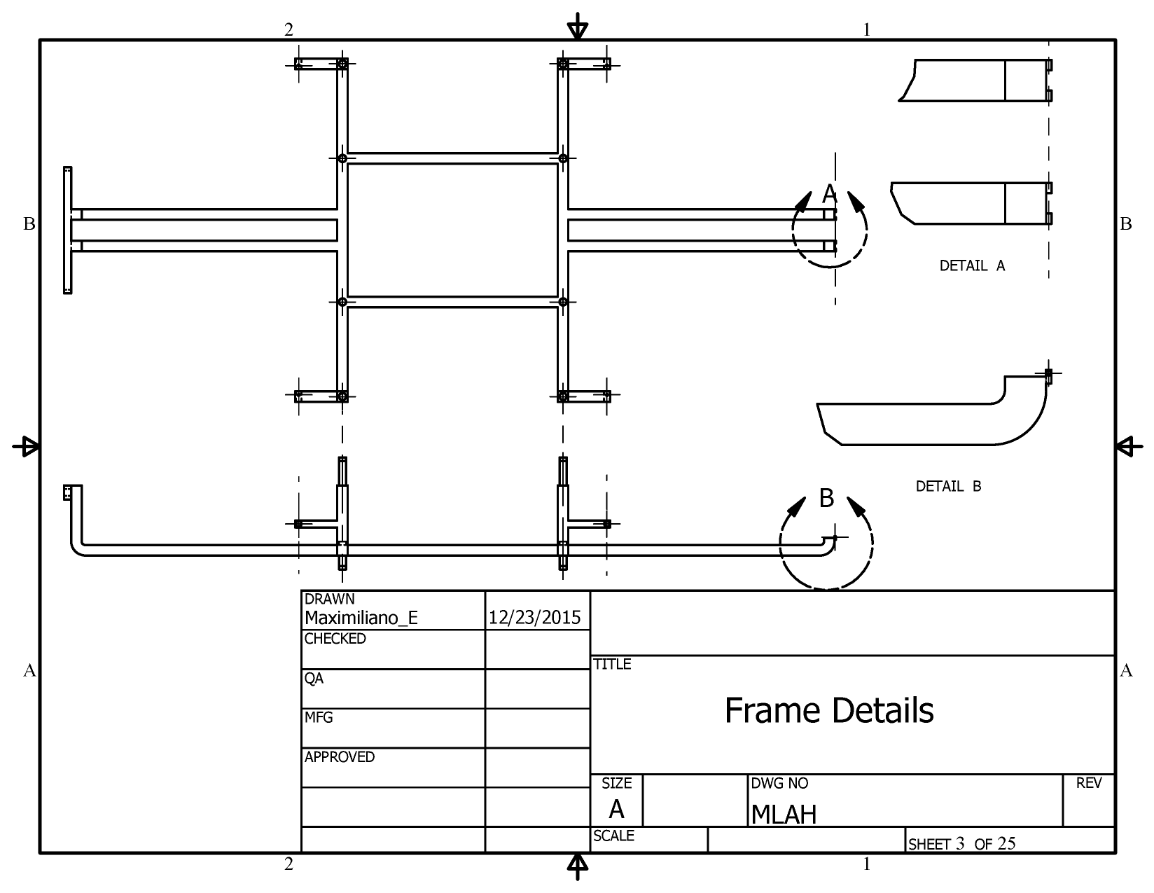

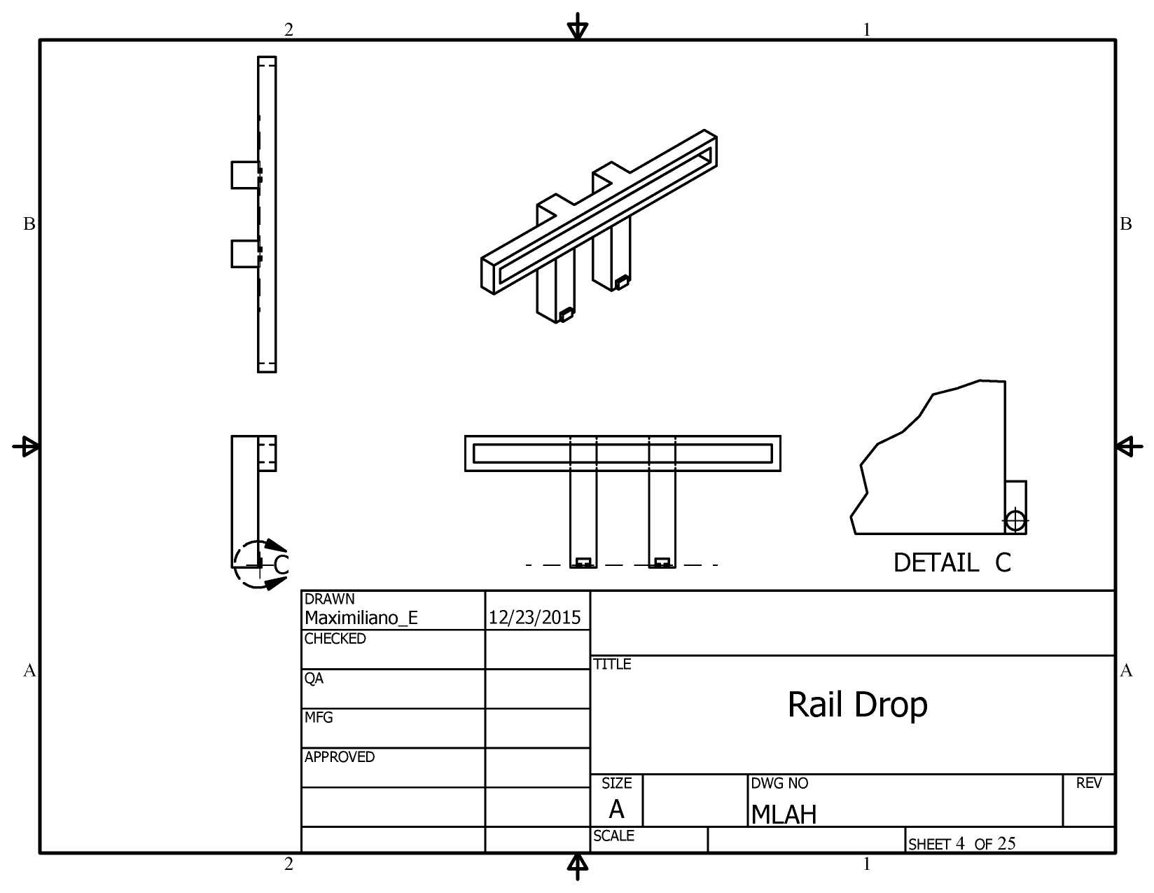

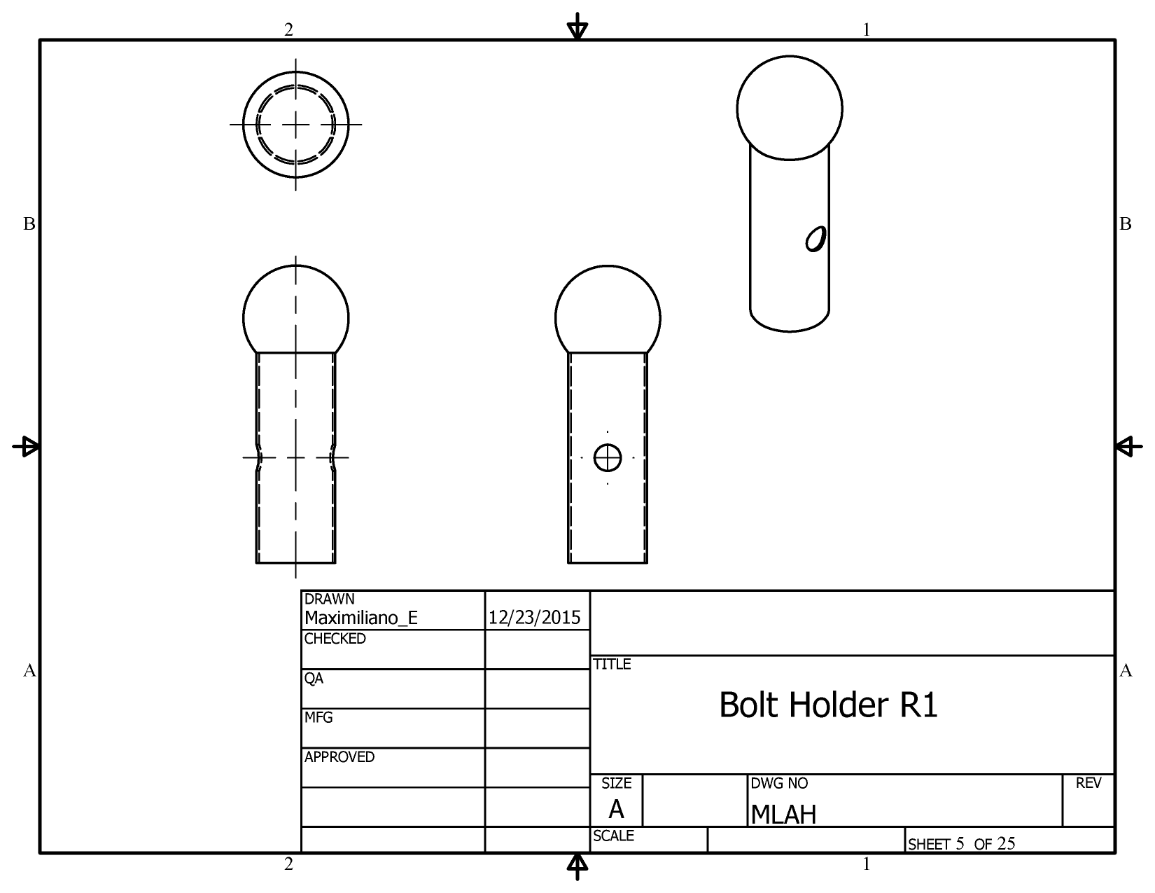

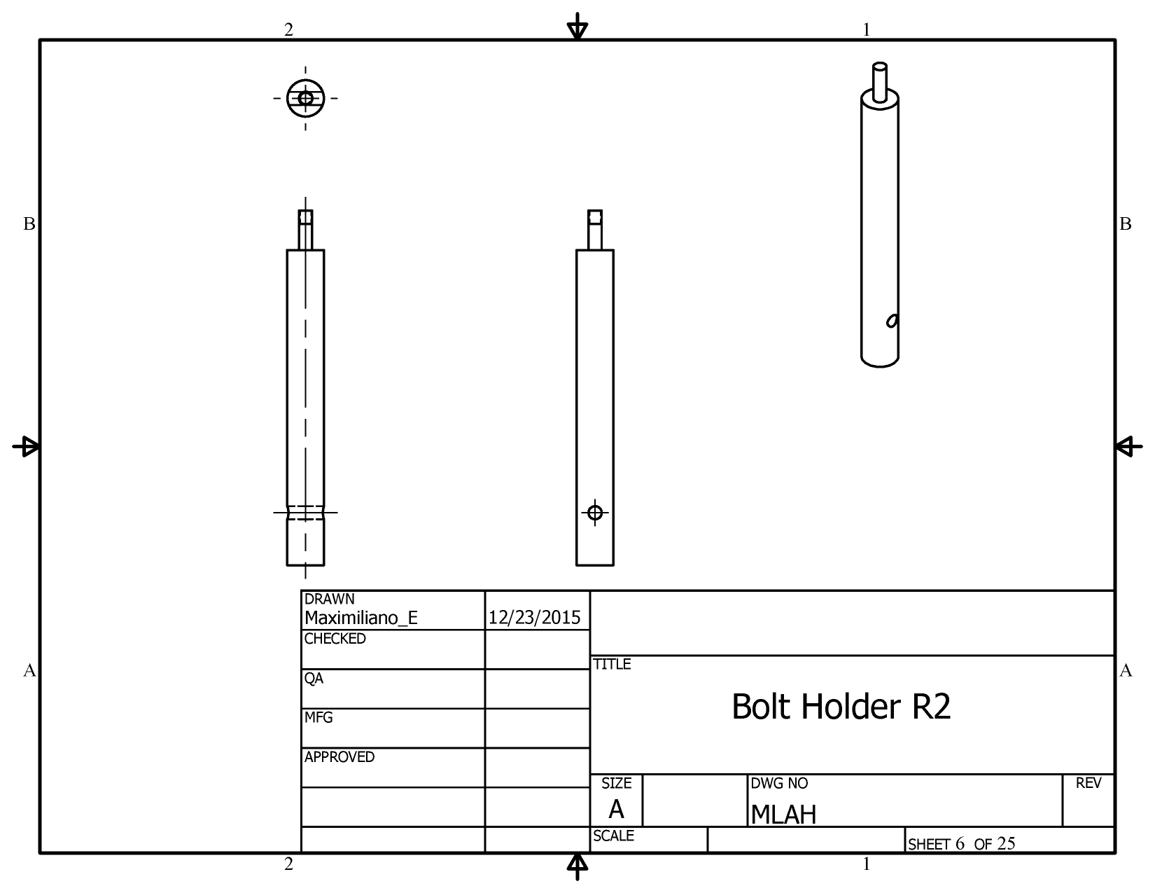

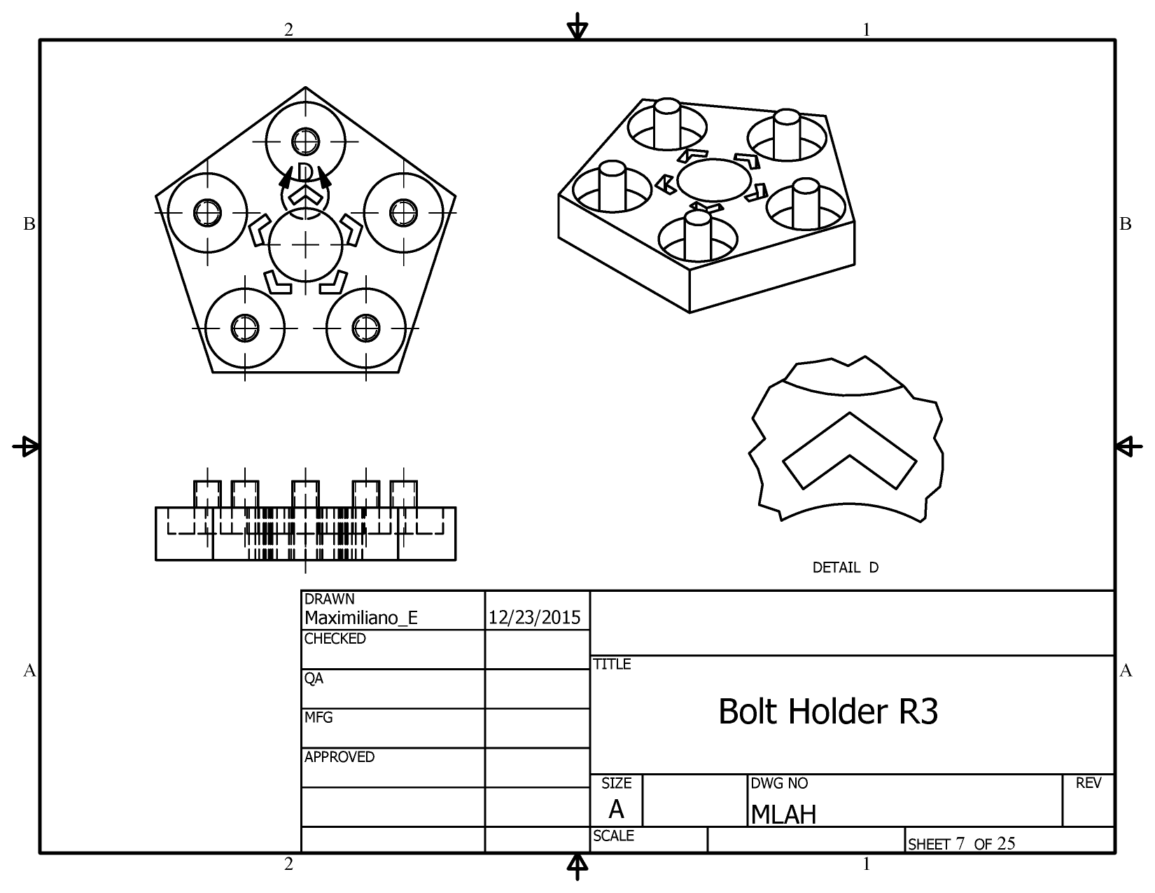

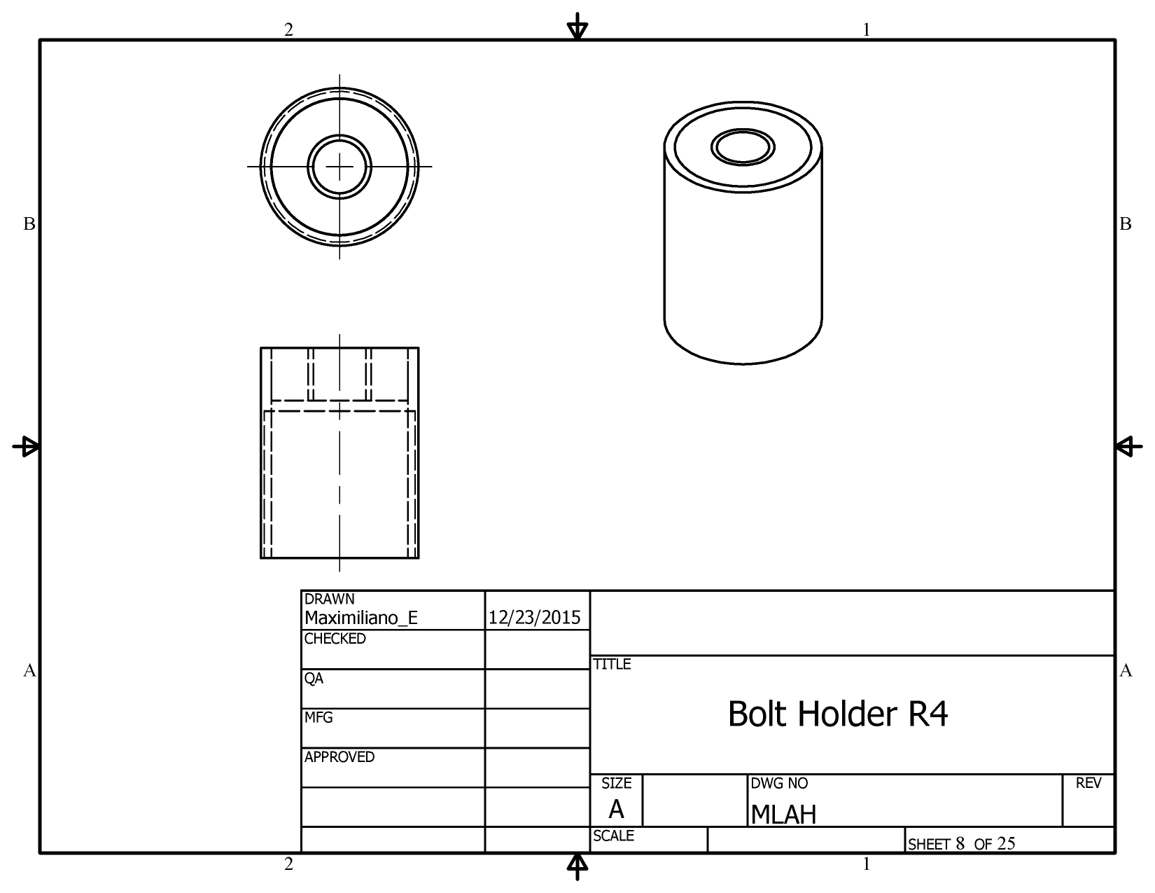

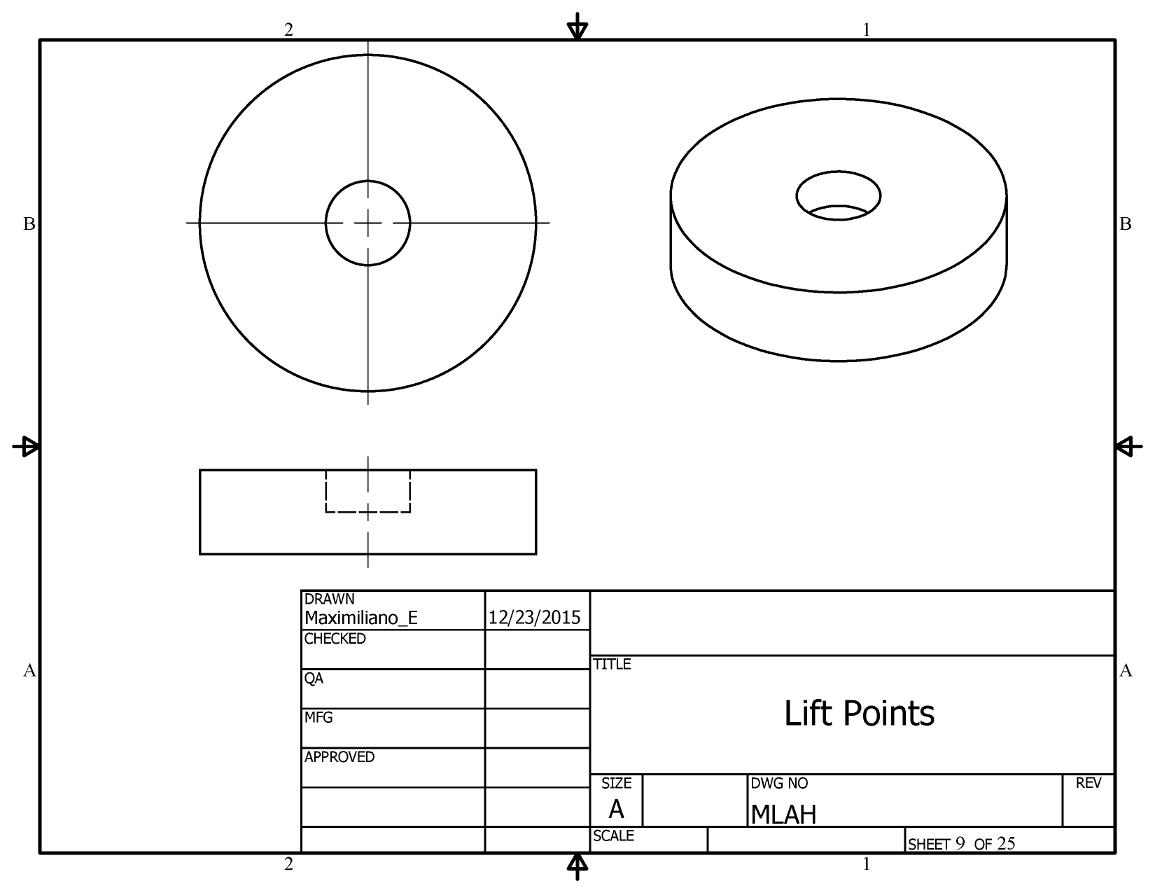

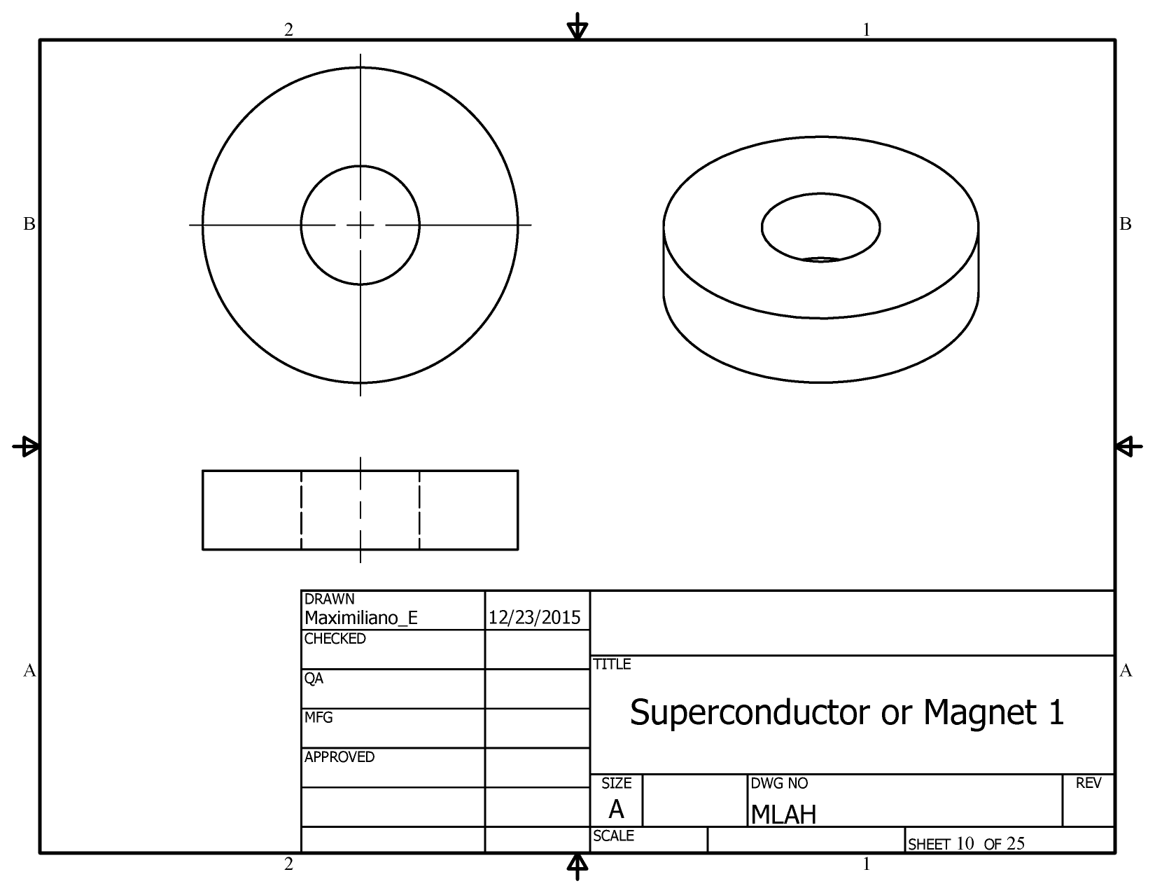

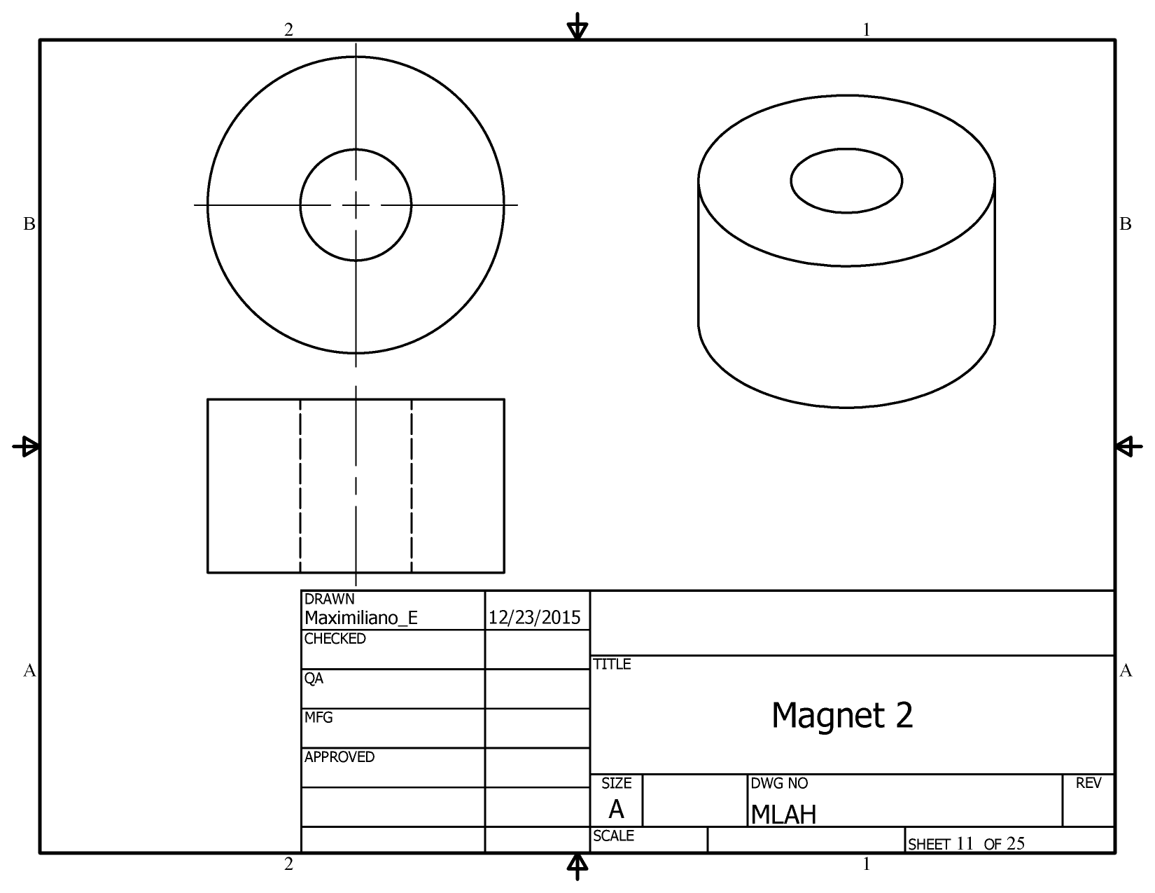

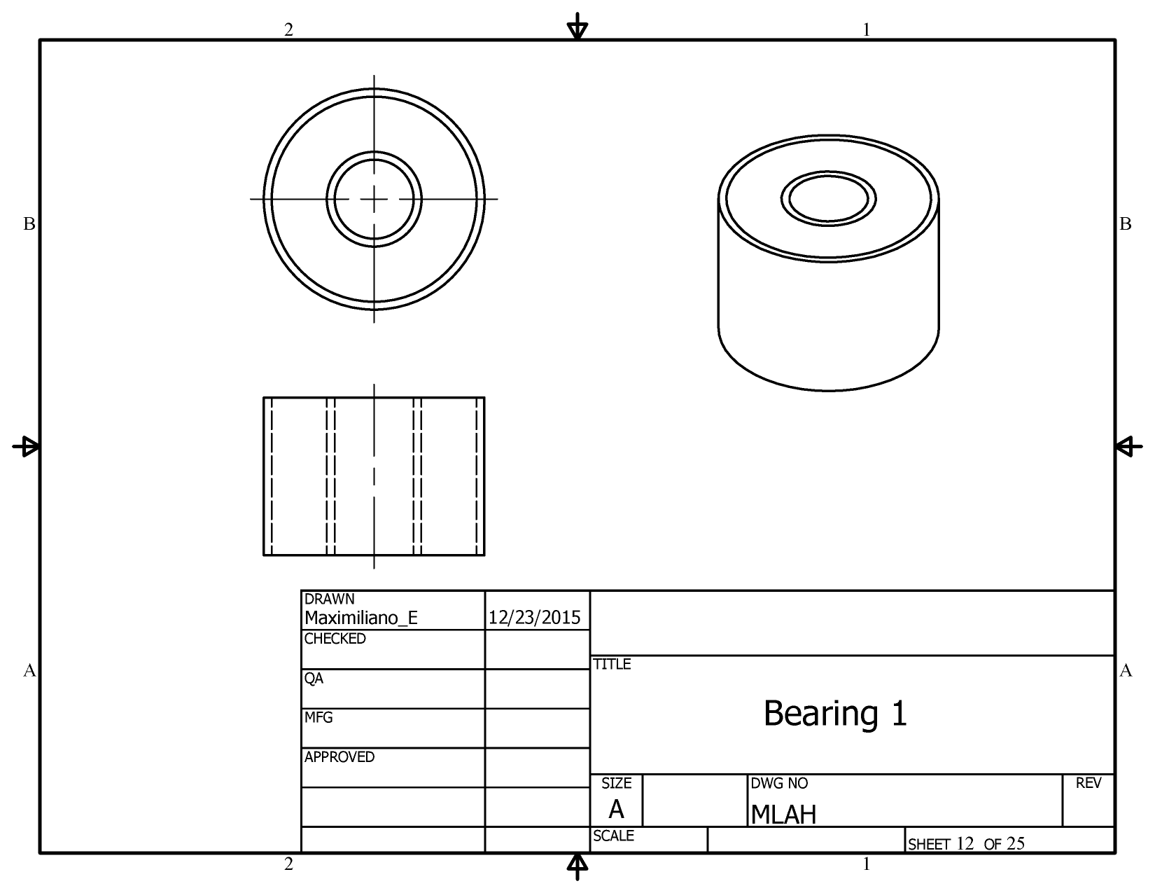

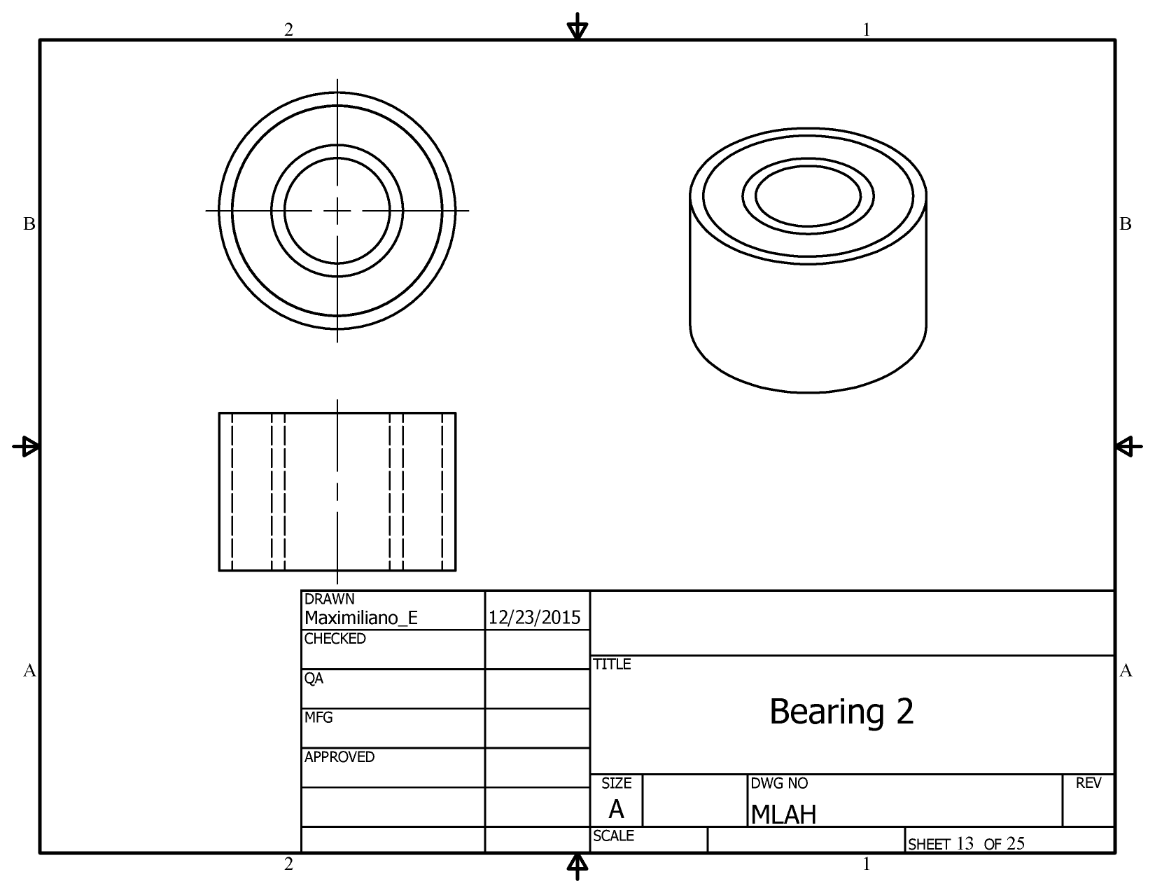

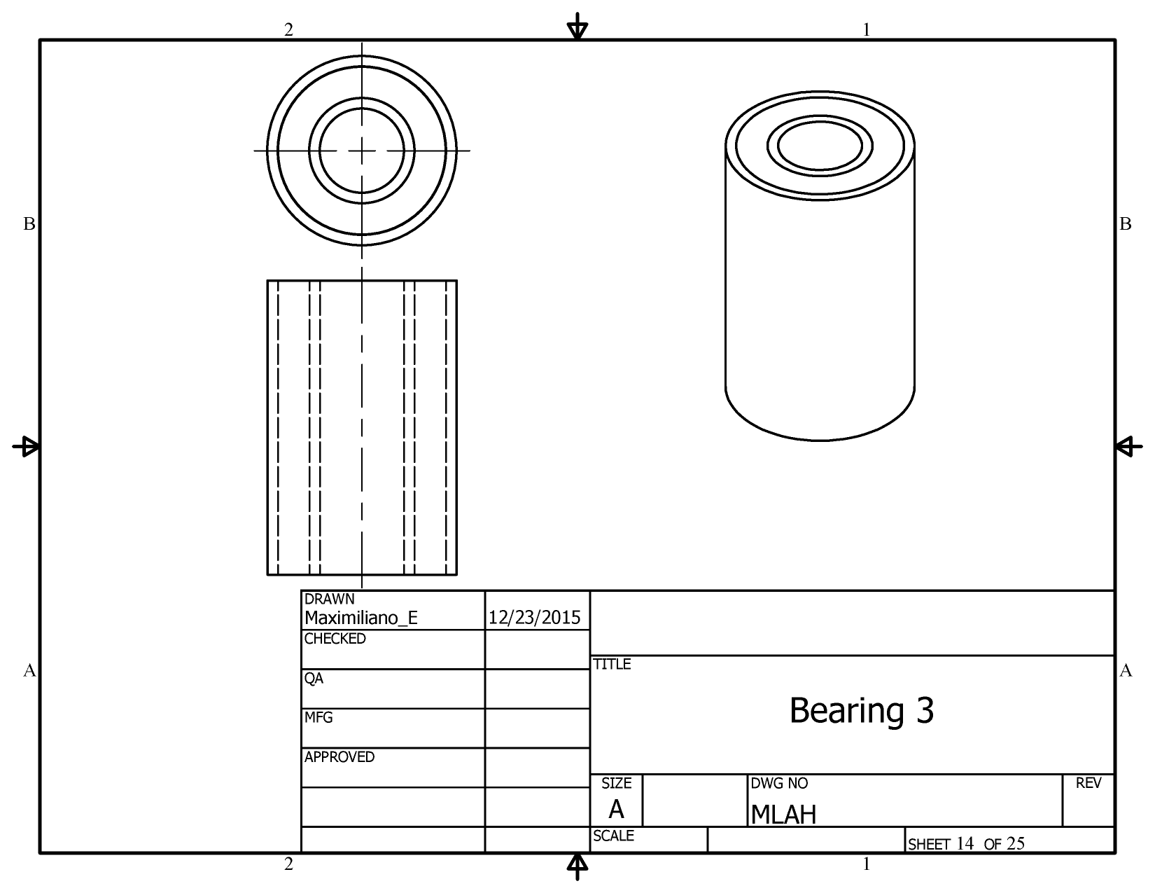

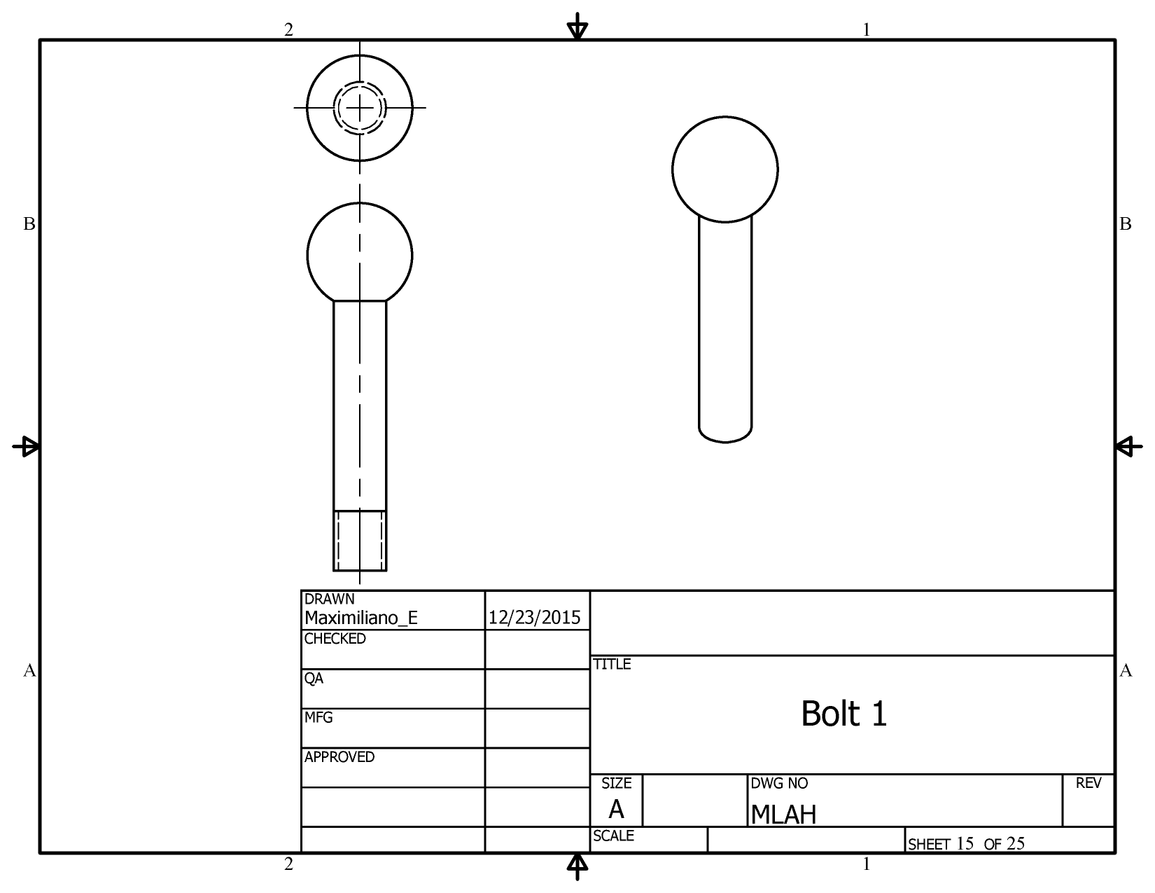

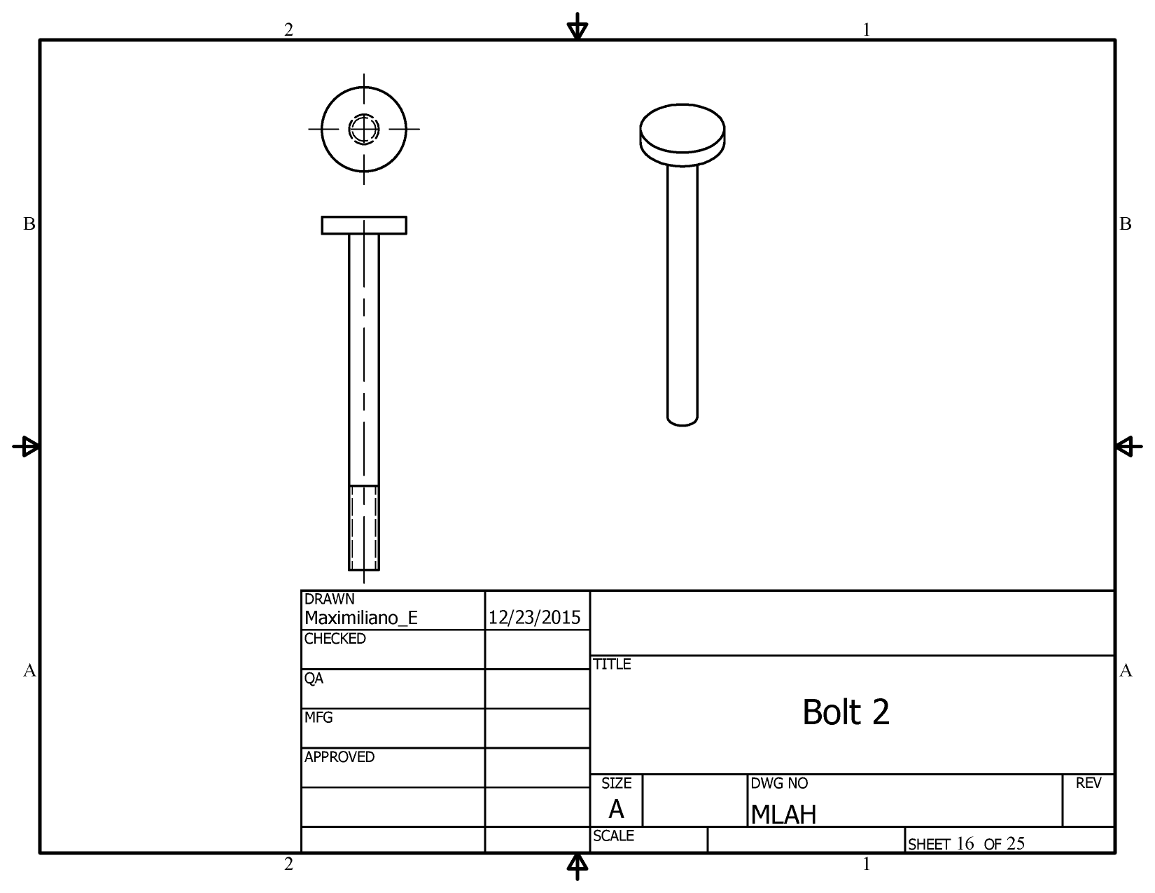

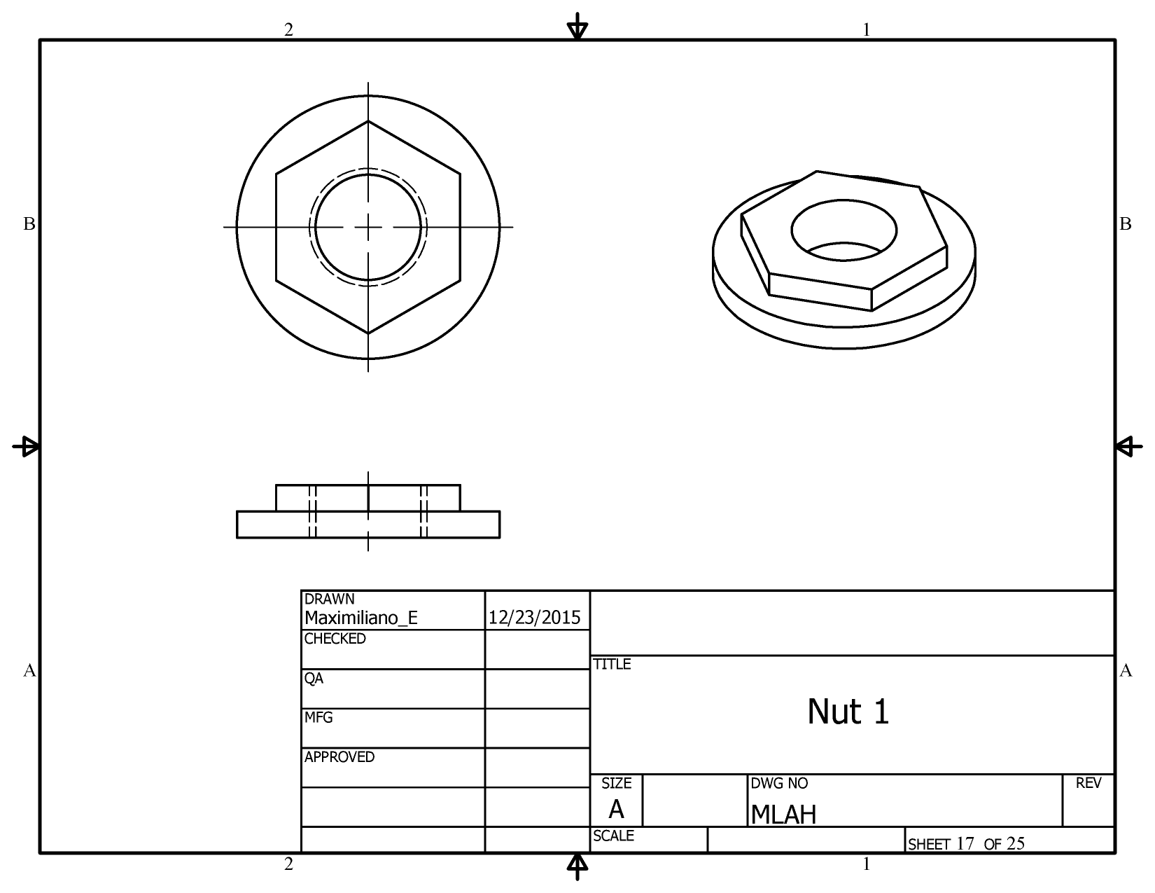

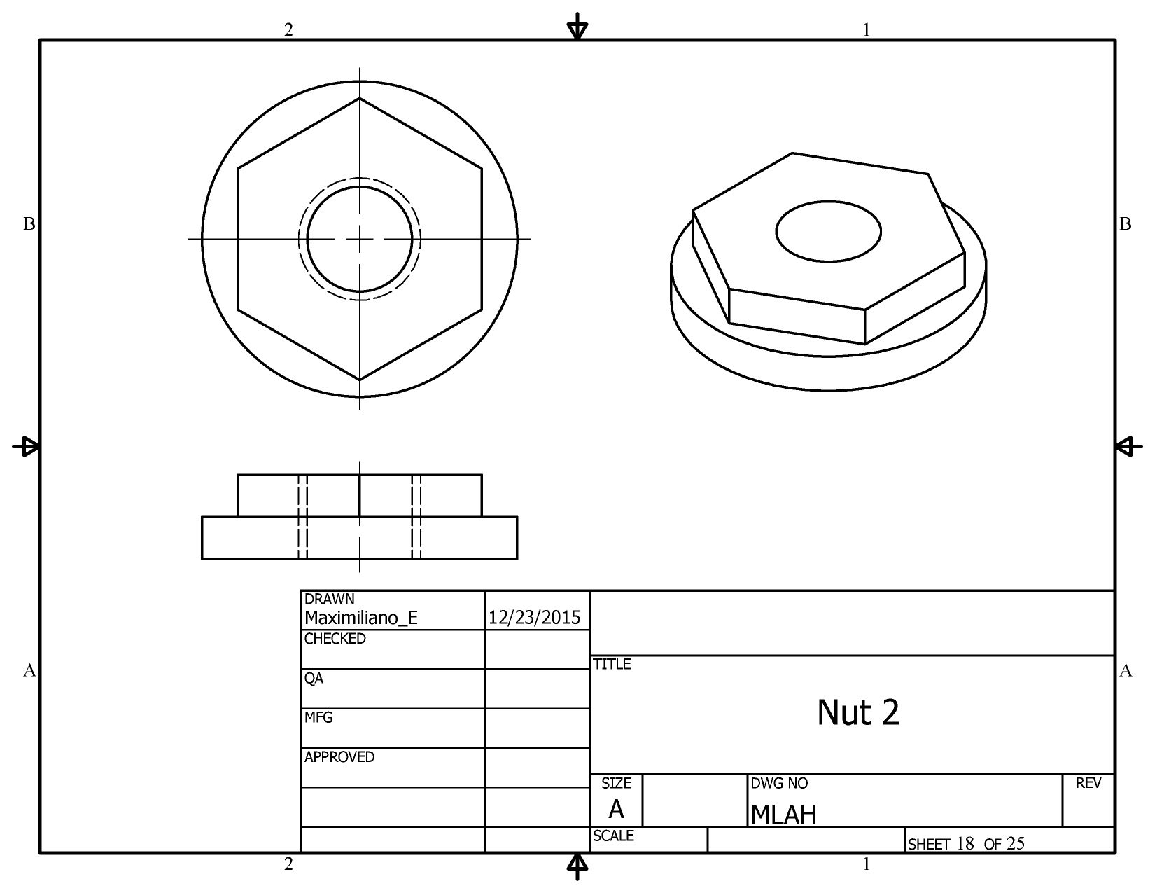

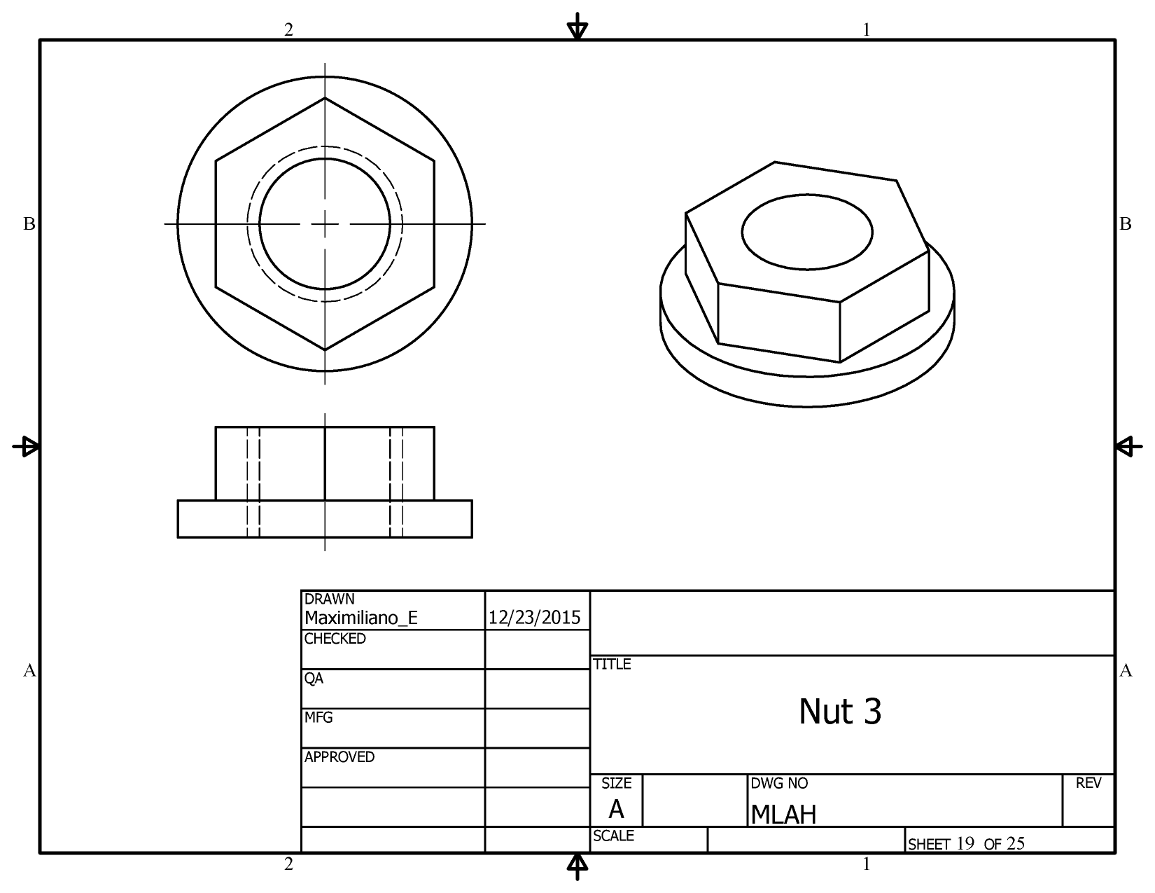

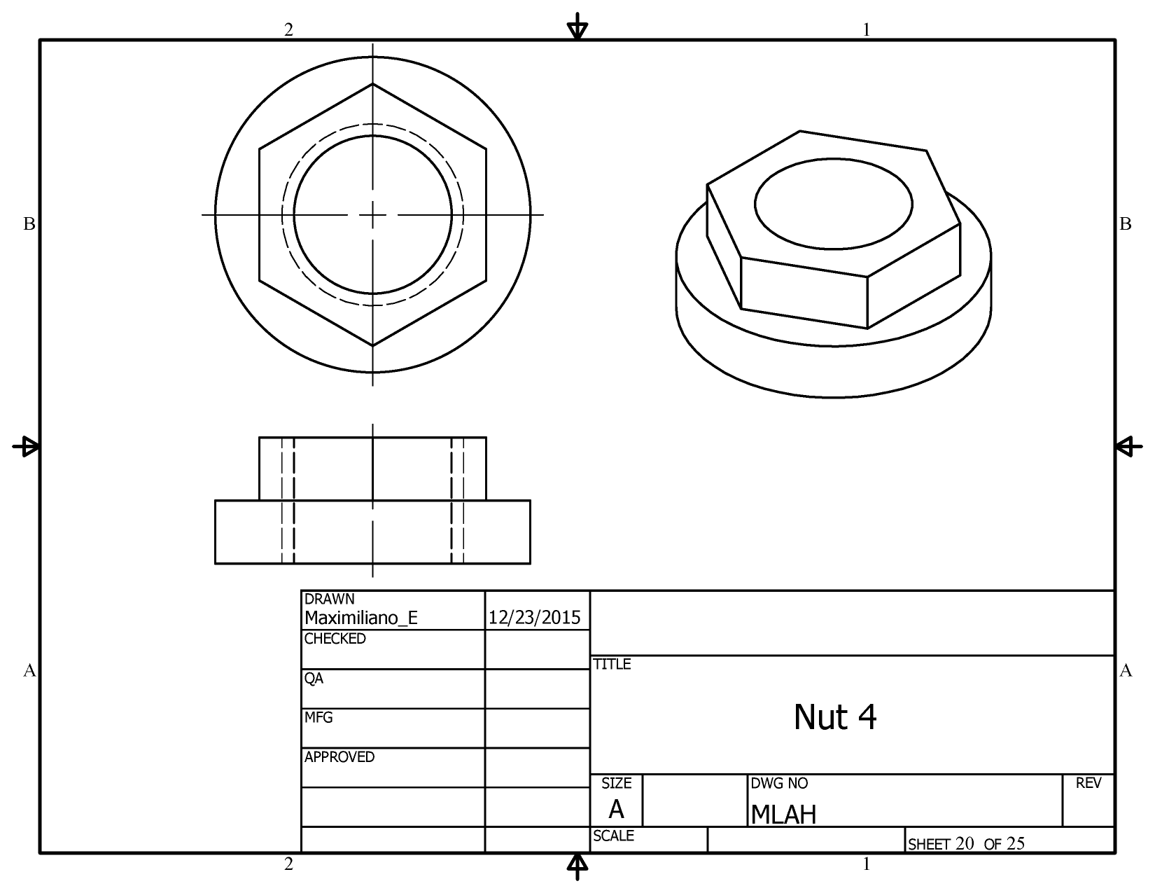

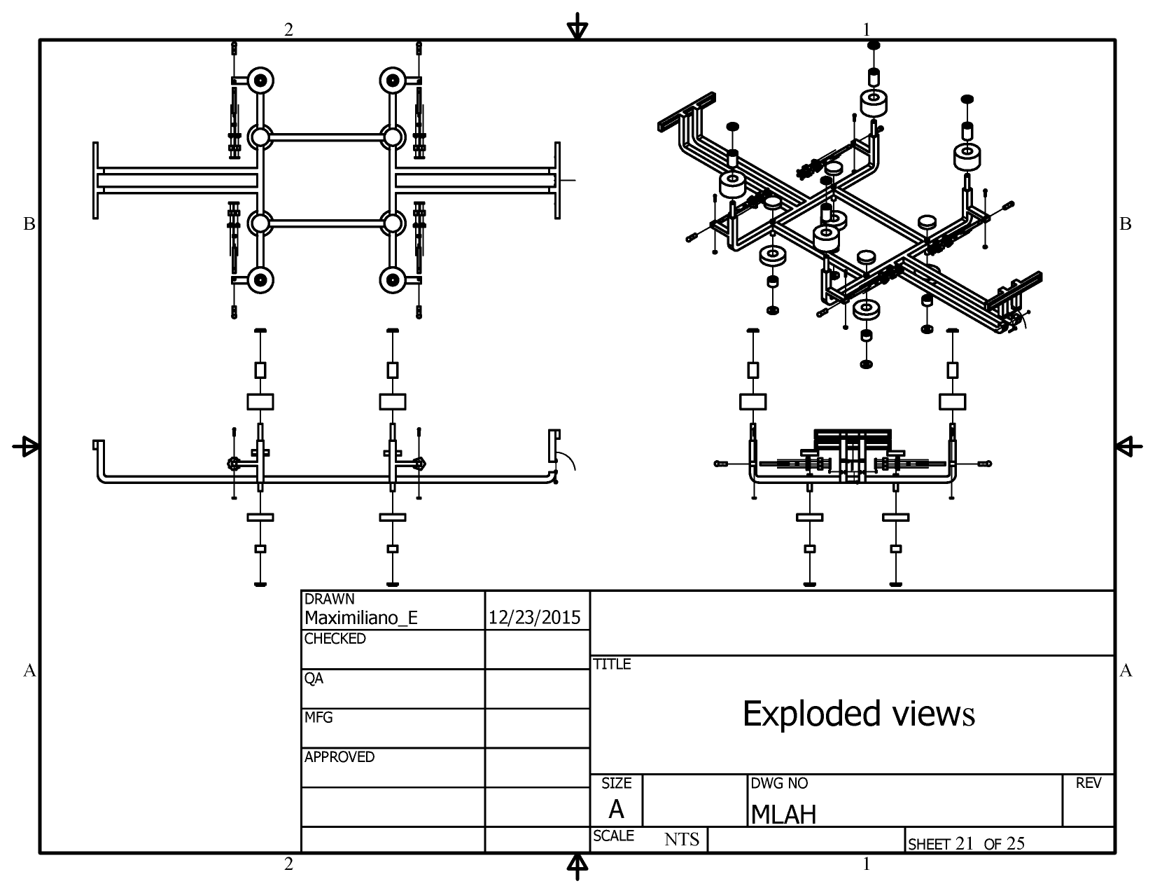

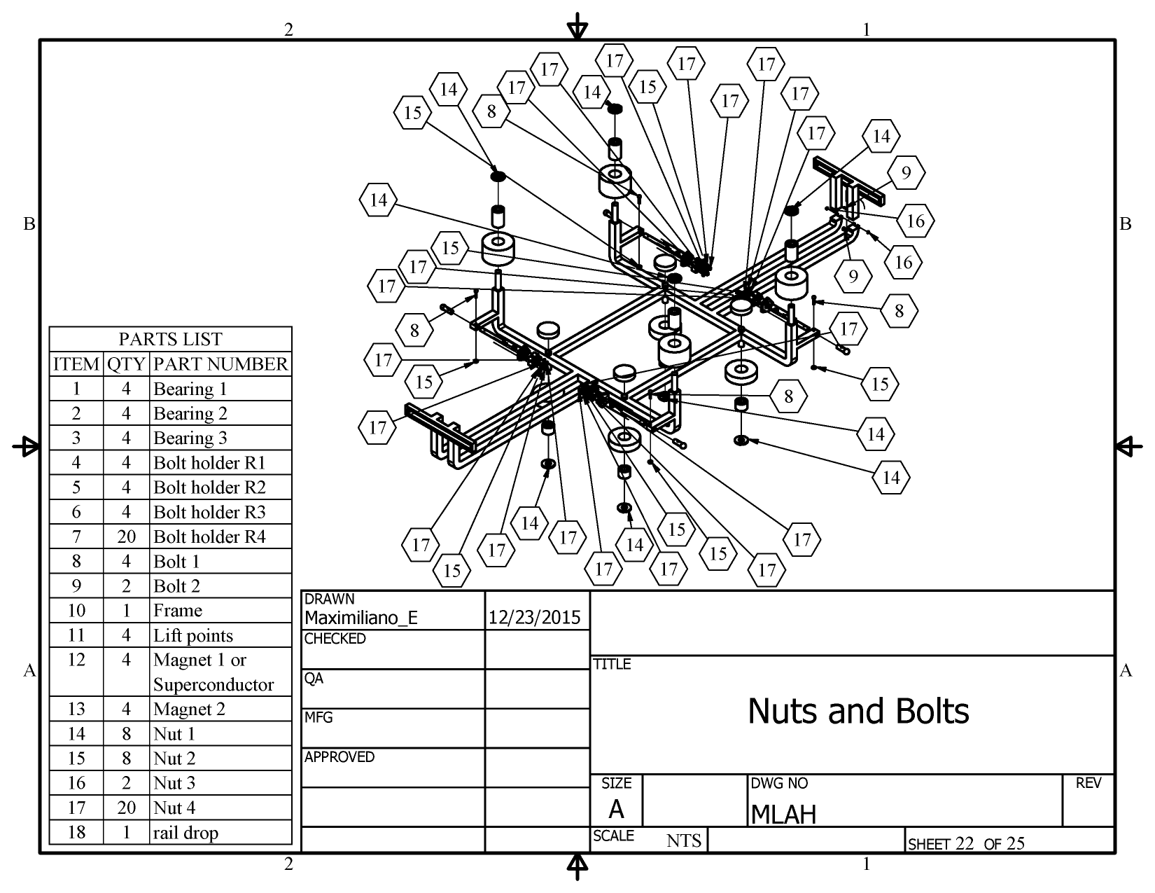

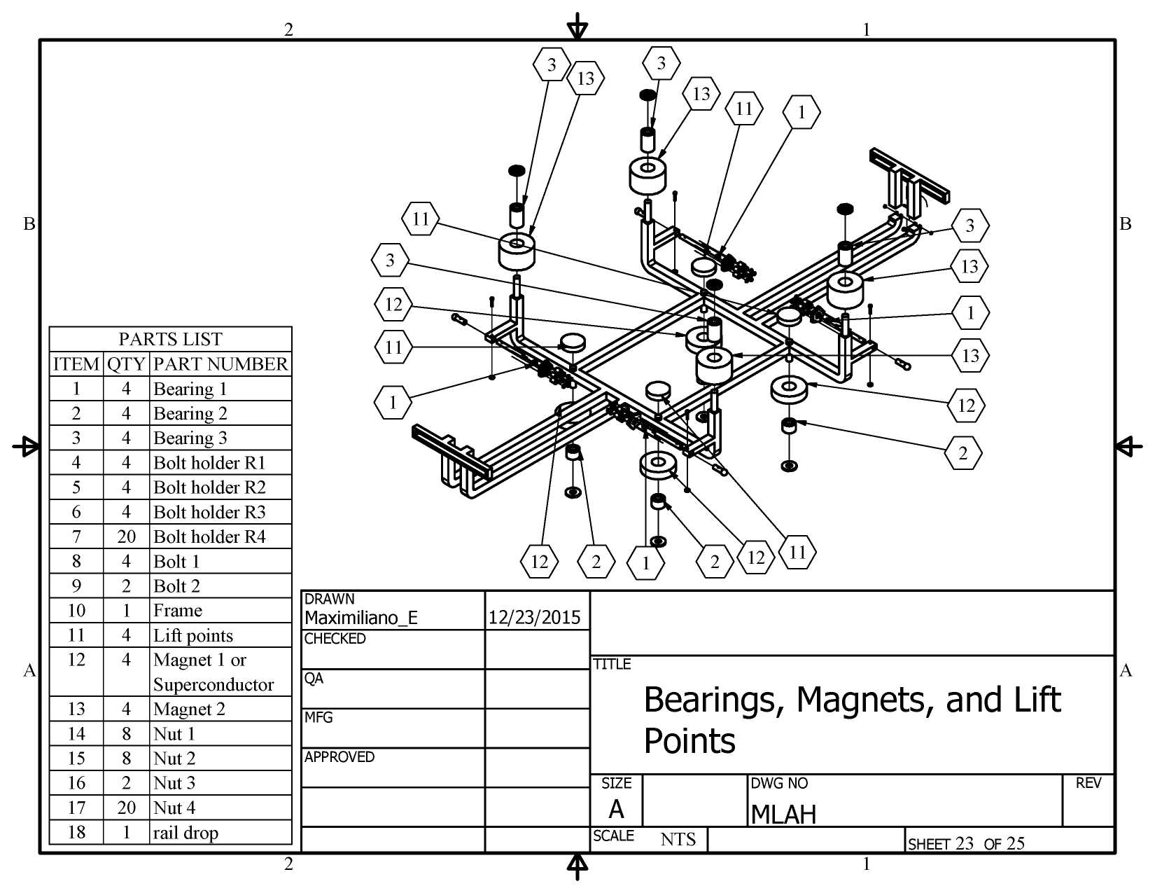

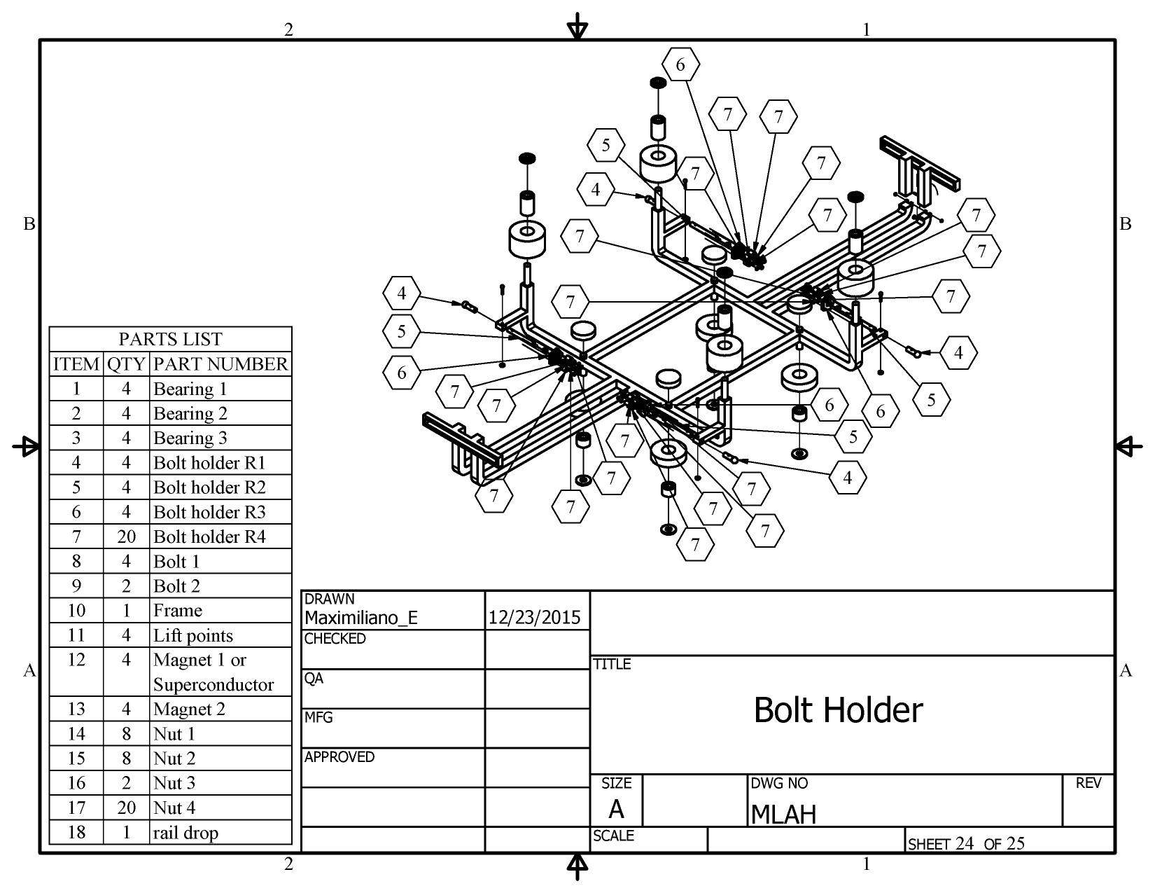

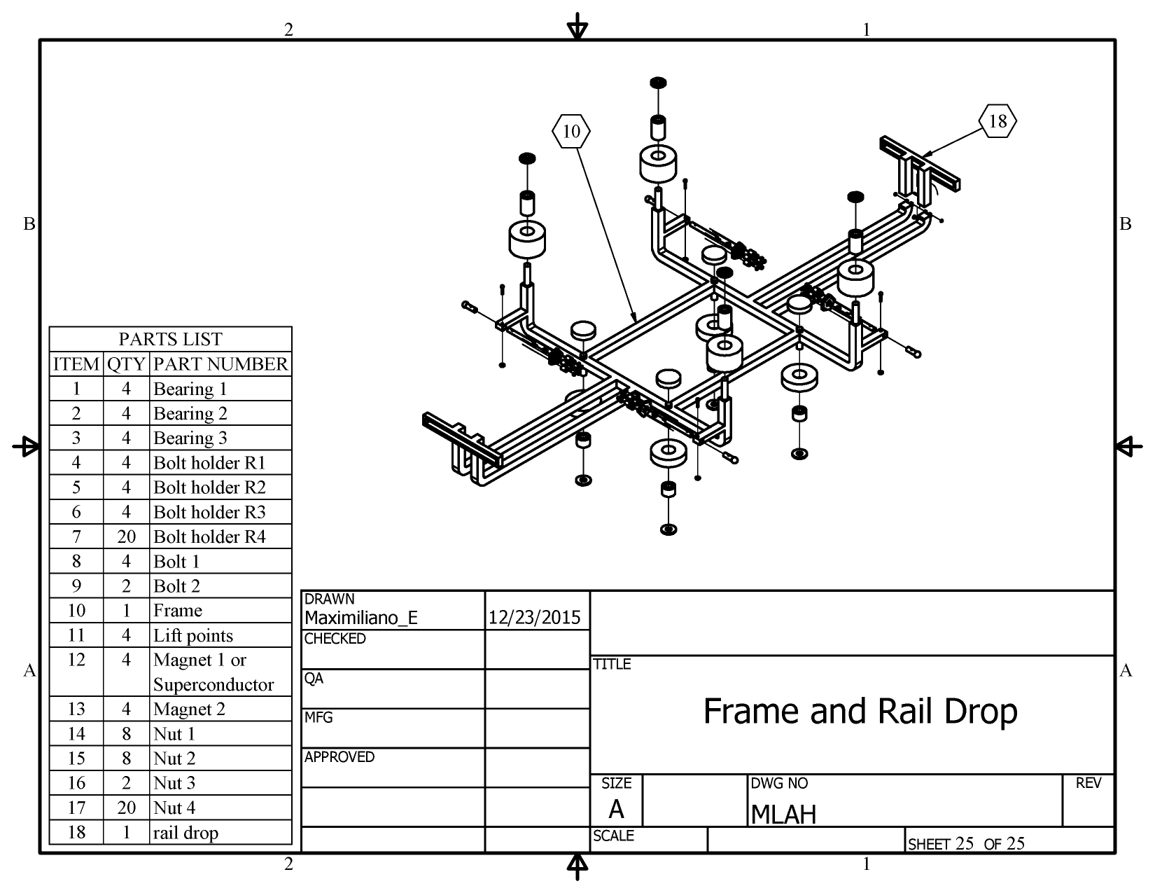

### BACKGROUND

Highway/freeway Accidents, highway/freeway fatalities, and highway/freeway traffic are all I hope to greatly reduce with my invention. These three problems all have a something in common they are all caused by human error. A driver distracted on their phone, doing their make up, or driving under the influence can cause an accident, a distraction, traffic, and the possibility of fatalities with in that accident due to human error.

### BRIEF SUMMARY OF THE INVENTION

The Magnetic Levitation Automobile Harness (MLAH) gives the possibility of having an automobile ride a modified magnetic levitation railing system. The harness gives the possibility of both levitation and propulsion which are both needed in order to make this way of transportation work. It also has a way to secure the automobile in a safe manner in order to keep the passengers and the automobile safe.

### BRIEF DESCRIPTION OF THE DRAWINGS

Sheet 1: Cover sheet

The cover sheet for the Magnetic Levitation Automobile Harness (MLAH). This is a drawing of the MLAH fully assembled.

Sheet 2: Frame

The drawing has two views of the frame. The frame is what holds all the components together. There is a place for the magnets, superconductor, lift points, bolt holder, and the rail drop.

Sheet 3: Frame Details

This drawing has some of the specific details of the frame. There are many slots or holes for bolts, screws, bolt holder, rail drop, and other components.

Sheet 4: Rail Drop

These are the views of the rail drop. The rail drop has slots or holes that connect to the frame. This is there so that the automobile can get in and out of the MLAH.

Sheet 5: Bolt Holder Part 1

This drawing has the views of one of four parts of the bolt holder. This part is to hold the other two parts to the frame and keep it stable.

Sheet 6: Bolt Holder Part 2

This drawing has the views of one of the four parts of the bolt holder. This part connects the bolt holder part 1 & 3 together.

Sheet 7: Bolt Holder Part 3

This drawing has the views of one of the four parts of the bolt holder. This part connects the wheels of the automobile to the rest of the bolt holder and the frame along with the bolt holder part 4. It allows the wheels to spin freely as the automobile travels forward.

Sheet 8: Bolt Holder Part 4

This drawing has the views of one of the four parts of the bolt holder. This part connects the wheels of the automobile to the rest of the bolt holder and the frame along with the bolt holder part 3. it allows the wheels to spin freely as the automobile travels forward.

Sheet 9: Lift Point

This drawing has the views for the four lift points. These are under the four lift points that most automobile frames have. They are connected to the frame.

Sheet 10: Superconductor or Magnet 1

This drawing contains the views of the superconductor or magnet 1. This is the superconductor or magnet 1 that goes under the frame. This is what creates the levitation necessary to have the possibility to move the MLAH forward with virtually frictionless movement.

Sheet 11: Magnet 2

This drawing is the views of the magnet 2. This magnet is on the upper part of the frame. This magnet is round and it helps the frame levitate. This also is there to help move the MLAH forward and to keep it on the tracks.

Sheet 12: Bearing 1

This drawing has the views of the bearing 1. This bearing is used in order to allow the wheels to freely spin in case of an emergency or while in transit. This bearing goes fits snug around the small end of the bolt holder part 2 and in the middle of the bolt holder part 3.

Sheet 13: Bearing 2

This drawing is of the views of the bearing 2. This bearing is used in order for the magnet or the superconductor to spin freely while in transit. The bearing goes inside the magnet 1 or superconductor and then attaches under the frame.

Sheet 14: Bearing 3

This drawing is of the views of the bearing 3. This bearing is used to allow the magnet 2 to spin freely In order for the magnet to move the MLAH forward along the track. This connects to the inner part of the magnet 2 then is attached to the frame.

Sheet 15: Bolt 1

These are the views of the bolt 1. This bolt is used to secure the complete bolt holder in place while in transit.

Sheet 16: Bolt 2

These are the views of the bolt 2. This bolt is used in order to secure and swivel the rail drop to the up and down positions.

Sheet 17: Nut 1

These are the views of the nut 1. This nut is used to secure the magnet 2 and the bearing assembled to the frame.

Sheet 18: Nut 2

These are the views of the nut 2. This nut is use to secure the bolt 1 and the assembled bolt holder to the frame. It also secures the bolt holder parts 2 & 3.

Sheet 19: Nut 3

These are the views of the nut 3. This nut is used to secure the bolt 2 and the rail drop to the frame.

Sheet 20: Nut 4

These are the views of the nut 4. This nut is used to help put together the bolt holder parts 3 & 4.

Sheet 21: Exploded Views

These are the views of the MLAH exploded.

Sheet 22: Nuts and Bolts Exploded View

This drawing is an exploded view of the MLAH. The part numbers are according to the part list this is for nuts and bolts.

Sheet 23: Bearings, Magnets, and Lift Points Exploded View

This drawing is an exploded view of the MLAH. The part numbers are according to the part list this is for bearings, magnets or superconductors, and lift points.

Sheet 24: Bolt Holder Exploded View

This drawing is an exploded view of the MLAH. The part numbers are according to the part list this is for the bolt holder.

Sheet 25: Frame and Rail Drop Exploded View

This drawing is an exploded view of the MLAH. The part numbers are according to the part list this is for the frame and rail drop.

### DETAILED DESCRIPTION AND BEST MODE OF IMPLEMENTATION

### Background Information

The automobile harness gives the ability to have automobiles ride along a modified magnetic levitation (MagLev) railing. It uses magnets and superconductors to achieve the possibility of transportation via magnetic levitation and propulsion. This harness uses magnet 2 along with a modified MagLev railing to keep the harness on the track. The magnet 2 and the modified MagLev railing also propels the harness forward. The magnet 1 or superconductor along with a modified MagLev railing keeps the automobile harness levitated throughout the track. Most of the harness will already be assembled it is only the Bolt Holder that will have to be reassemble to secure the harness to the automobile.

### Assembly

For the assembly look on SHEET 21-24.

### Implementation Process

The automobile pulls up to the harness area. The Bolt Holder R2-R4 is attached to the automobile wheels. The rest of the harness is attached by connecting the Bolt Holder R1 to the Bolt Holder R2 as well as to the frame. Once everything is secured the driver will move to the modified MagLev railing. The modified MagLev railing will pick up and push the harness forward on the track to its destination. This is possible due to the bearings allowing the magnets and superconductors to spin freely. The bearings in the Bolt Holders allow the automobiles wheels to turn and spin as the harness is pushed off onto a platform or ramp at its destination to be disassembled off the automobile. The assembling and disassembling process can also be on a conveyer belt and have machines assemble and disassemble the bolt holder and the rest of the harness onto the automobile.

1) The four lift points that alt automobile frames have.

2) The magnets or superconductors needed in order to levitate the automobile.
a. If the superconductor is chosen; it will also need some sort of container for the liquid hydrogen needed.

3) The magnets needed in order to propel the automobile forward and keep the MLAH on the modified magnetic levitation railing system.
a. The magnets will also have to have some sort of bearing in the inner diameter of the magnet in order to allow the magnet to spin.

4) A durable and strong frame to hold all the components of the MLAH together.
a. Addition to the frame the rail drop is also needed in order to have the capability to attach or connect the automobile to the MLAH.

5) The bolt holder needed in order to hold the wheels of the automobile in place and intact during transit.
a. This includes all the parts that make up the bolt holder.
